(19) United States
(12) Patent Application Publication
(10) Pub. No.: US 2002/0165815 A1
(43) Pub. Date: Nov. 7, 2002

(54) Online marketplace with anonymous communication

(75) Inventor: Christopher R. Vincent, Arlington, MA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY

(21) Appl. No.: 10/022,563

(22) Filed: Dec. 12, 2001

Related U.S. Application Data
(63) Continuation-in-part of application No. 09/850,343, filed on May 7, 2001.
(63) Continuation-in-part of application No. 09/850,390, filed on May 7, 2001.

(51) Int. Cl. G06F 17/60; G06F 15/173

(52) U.S. Cl. 705/37; 705/26; 709/223; 709/239

(57) ABSTRACT

A method is provided for operating an online marketplace. According to the method, a request for bid for a good or service that does not identify the purchaser is received from a purchaser and transmitted to a plurality of sellers via an electronic network. At least one offer for the good or service is received from at least one of the sellers via the electronic network, with the sellers sending the offers not knowing the identity of the purchaser that will receive the offers. The offers are transmitted to the purchaser. In one preferred embodiment, a purchase order identifying the purchaser is communicated from the purchaser to one of the sellers that submitted an offer in order to purchase the good or service. Also provided are methods for communicating between a purchaser and one or more sellers in an online marketplace.

### CROSS-REFERENCE TO RELATED APPLICATIONS

This application is a continuation-in-part of prior U.S. application “Scalable Resource Discovery and Reconfiguration for Distributed Computer Networks,” Ser. No. 09/850,343, filed May 7, 2001, now______, and a continuation-in-part of prior U.S. application “System and Method for Responding to Resource Requests in Distributed Computer Networks,” Ser. No. 09/850,390, filed May 7, 2001, now______, both of which are commonly assigned herewith to International Business Machines Corporation.

### BACKGROUND OF THE INVENTION

1. Field of the Invention

The present invention relates to conducting commerce with the assistance of electronic communications, and more specifically to a system and method for forming business agreements utilizing a communications network that supports anonymous data exchange.

2. Description of Related Art

Computer networks such as the Internet allow users to easily communicate with a large and diverse group of individuals and companies. The expansion of the Internet and the adoption of standards for electronic mail, the interchange of data files and viewing information via the World Wide Web have made communicating information as well as the exchanging, viewing and downloading of files by a user almost effortless. The user need not know any programming languages. Users may simply draft text messages and electronically send them with nearly instant delivery to any individual or entity with an Internet e-mail address. By simply using a widely available Internet browser, the user similarly needs to only point and click in order to nearly instantly view and download desired files. The widespread availability of programs to implement e-mail and Internet browsing allows for easy and rapid communications, collaboration and data sharing among individuals separated by great distances over a distributed computer network, which can literally span the entire globe.

The widespread and nearly instant communications provided by the world wide Internet computer network have been broadly adapted to facilitate commerce. Retailers and other providers of goods and services have developed data servers known as Internet web sites, which are viewed by a remote user with an Internet browser, that present offers for the provider's goods and services. Various “marketplaces” have similarly been established where prospective purchasers of goods and services may list either an interest in purchasing or even a more formal request for a bid to sell a particular good or service. These marketplaces also facilitate a bidding system and the forming of agreements between users to buy and sell goods and services. These electronically based commerce applications, which are sometimes referred to as electronic commerce, are typically based upon a distributed computer network that interconnects purchasers and sellers of the goods and services offered for sale.

Conventionally, a distributed computer network has a client/server framework. In particular, each user is a client that can access a server node over the network and, with the proper authorization, publish files to the server node. Once a file is published to the server node, other clients on the network can access the server node to view or download the file. Additionally, the server node can allow a client to automatically send a file to another client that is reachable over the network. The client simply sends the file to the server node along with information identifying the desired recipient, and the server node sends the file on to the corresponding client. In an electronic commerce environment, purchasers and sellers of goods and services publish data files identifying a purchaser's interest and transmit and receive files containing a seller's offer, a purchaser's purchase order or other data associated with a business transaction.

With such a client/server framework, the server node is charged with providing security. For example, the server node must insure that only authorized clients can use the network resources (e.g., download files), and that only proper files are published. Additionally, the server node represents a single point of failure. Thus, in any client/server environment in which reliability is required, the server node must be of industrial strength and have redundant systems to prevent system shutdowns and data loss. Further, because all client-to-client resource transfers pass through the server node, the adding of another client to the network puts an additional burden on the server node and degrades network performance.

In such a client/server framework, the clients have little privacy. Typically, the server node requires authentication before allowing a client to access network resources. Once the client has provided authentication credentials, the server node can easily log all of the network activity of the client. For example, the server node could keep a log of all files uploaded and downloaded by the client. Even if access by unauthenticated clients is allowed, the server node can use any of various unique identification techniques to track client activity over time. For example, the server node can place a unique cookie on the client and later use the cookie to identify the client each time it accesses the server node. Thus, in an electronic commerce environment, the purchasers and sellers are offered little privacy when communicating through a client/server framework.

One solution to some of the drawbacks of the conventional client/server framework is provided by a “viral” network. In such a network, a user node connects to one or more known hosts that are participating in a highly interconnected virtual network. Then, the user node itself becomes a host node that can respond to requests for resources and available hosts. Each user in the network forwards resource requests (e.g., requests for products and services) to all known neighboring nodes, so as to potentially propagate each request throughout the entire network. For example, the Gnutella system employs such a viral network framework. Gnutella has a published network protocol and provides users a client/server application (available at http://gnutella.wego.com) that allows each user to act as a host node in a file sharing network. The Gnutella system can be used to securely distribute files and other content.

Viral networks are based on peer-to-peer communication. Peer-to-peer is a communications model in which each party has similar capabilities and either party may initiate a communication session. For example, the Gnutella application employs peer-to-peer communication to allow users to exchange files with one another over the Internet. The peer-to-peer model used in a viral network relies on each peer (i.e., user node) having knowledge of at least one of the other peers in the network. When searching for a resource such as a product or service, a peer sends a resource request to other known peers, which in turn pass it on to their known peers and so on to propagate the request throughout the network. A peer that has the resource and receives the request can send a message indicating its availability back to the requesting peer. Because such a framework offers independence from a centralized network authority (e.g., server node), users in a viral network have enhanced privacy and the single point of failure is eliminated.

FIG. 1 shows an exemplary viral network. Each node in the network represents a user that acts both as a client and host, and is connected with one or more other nodes. When a first node 210 desires a particular resource (e.g., a file containing information related to a product or service), the first node 210 issues a request to all known nodes 202, 204, 206, and 208, which in turn do the same. For example, the request reaches a second node 212 by being passed in succession through nodes 208, 216, and 218. If the second node 212 has the requested resource, it responds by sending an appropriate message to the first node 210 (e.g., back the same path that the request traversed). Because a node having the requested resource has been identified, the first node 210 can initiate a direct peer-to-peer connection with the second node 212 in order to communicate regarding the resource. Throughout the viral network, any number of such resource requests, acknowledgments, and transfers can occur simultaneously.

While viral networks offer enhanced privacy and eliminate a single point of failure, the framework has drawbacks related to scalability. In a large, decentralized viral network, efficient resource discovery breaks down as the number of participating nodes increases. More specifically, a resource request can only propagate from node to node, and each node only propagates the request to a relatively small number of other nodes. To control network traffic and prevent unreasonable response times, a practical system must employ a “time-to-live” or some limit on the number of times a request can be forwarded (i.e., a maximum number of peer hops). This effectively disconnects any two nodes or groups of nodes that are separated by a path that would require a request to propagate through an unreasonably large number of intermediary nodes. Further, any such limit on request propagation makes it impossible to perform an exhaustive search for a resource, because such a search would require the request to be propagated to all of the nodes in the network.

Additionally, there has recently been proposed a content-based publish-subscribe messaging infrastructure that utilizes an information flow graph. For example, the Gryphon system (described at http://www.research.ibm.com/gryphon) has been developed by the assignee of the present invention. This system provides a content-based subscription service and performs message brokering by merging the features of distributed publish/subscribe communications and database technology. At the core of the Gryphon system is an information flow graph that specifies the selective delivery of events, the transformation of events, and the generation of new events.

FIG. 2 shows an exemplary content-based publish-subscribe messaging infrastructure that utilizes information flow graphs. In this system, stocks trades derived from two information sources NYSE and NASDAQ are combined, transformed, filtered and delivered to subscribing clients. For example, one user 312 subscribes to the message-brokering server 302 and requests to receive all stock trades on both the NYSE and NASDAQ that have a value of over one million dollars. The message broker 302 receives raw stock trade information such as price and volume from the NYSE 324 and NASDAQ 326.

Based on the information request of the user 312, the server 302 merges the stock trade information from the two sources, transforms the raw price and volume information into value information for each trade, and then filters the derived values to produce the subset of trades that are valued at over one million dollars. In a similar manner, each subscribing user (e.g., nodes 304, 306, and 308) specifies its own criteria, and the message-brokering server 302 performs information selection, transformation, filtering, and delivery in order to provide each user with the requested information.

While the publish-subscribe messaging infrastructure of FIG. 2 provides good scalability for a messaging system with a large number of users, as in the conventional client/server framework the users have little privacy. All users must identify themselves when subscribing to the system and all information is delivered to the user through the centralized server. Thus, the centralized server can easily maintain a log of all users of the system and the exact information that each desires and receives. The centralized message-brokering server also represents a single point of failure for the system.

### SUMMARY OF THE INVENTION

In view of these drawbacks, it is an object of the present invention to remove the above-mentioned drawbacks and to provide systems and methods for creating an online marketplace such as a bidding system that supports anonymous communications.

One embodiment of the present invention provides a method for communicating between a purchaser and a plurality of sellers in an online marketplace. According to the method, a request for bid for a good or service that does not identify the purchaser is transmitted to the sellers via an electronic network. At least one offer for the good or service is received from at least one of the sellers via the electronic network, with the sellers sending the offers not knowing the identity of the purchaser that is receiving the offers. After receiving the offers, a purchase order identifying the purchaser is communicated to one of the sellers that submitted an offer in order to purchase the good or service.

Another embodiment of the present invention provides a method for communicating between a purchaser and a seller in an online marketplace. According to the method, a request for bid for a good or service that does not identify the purchaser is received from the purchaser via an electronic network. An offer for the good or service is transmitted to the purchaser via the electronic network, with the seller sending the offer not knowing the identity of the purchaser that is receiving the offer. A purchase order identifying the purchaser is received from the purchaser so as to form a contract for purchasing the good or service.

Yet another embodiment of the present invention provides a method for operating an online marketplace. According to the method, a request for bid for a good or service that does not identify the purchaser is received from a purchaser and transmitted to a plurality of sellers via an electronic network. At least one offer for the good or service is received from at least one of the sellers via the electronic network, with the sellers sending the offers not knowing the identity of the purchaser that will receive the offers. The offers are transmitted to the purchaser. In one preferred embodiment, a purchase order identifying the purchaser is communicated from the purchaser to one of the sellers that submitted an offer in order to purchase the good or service.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a diagram of an exemplary viral network;

FIG. 2 is a diagram of an exemplary content-based publish-subscribe messaging infrastructure;

FIG. 3 is a data communications diagram illustrating the communication of data between a purchaser and a seller in accordance with one embodiment of the present invention;

FIG. 4 is a flow chart of a purchaser and a seller exchanging information in accordance with one embodiment of the present invention;

FIG. 5 shows XML data for a request for bid according to an exemplary embodiment of the present invention;

FIG. 6 shows XML data for an offer according to an exemplary embodiment of the present invention;

FIG. 7 is a diagram of a scalable network framework in which an online marketplace is implemented according to one preferred embodiment of the present invention;

FIG. 8 is a flow chart of one embodiment of a process for obtaining a resource within the scalable network framework;

FIG. 9 is a diagram of the scalable network framework showing an exemplary implementation of part of the process of FIG. 8; and

FIG. 10 is a diagram of the scalable network framework showing an exemplary implementation of another part of the process of FIG. 8.

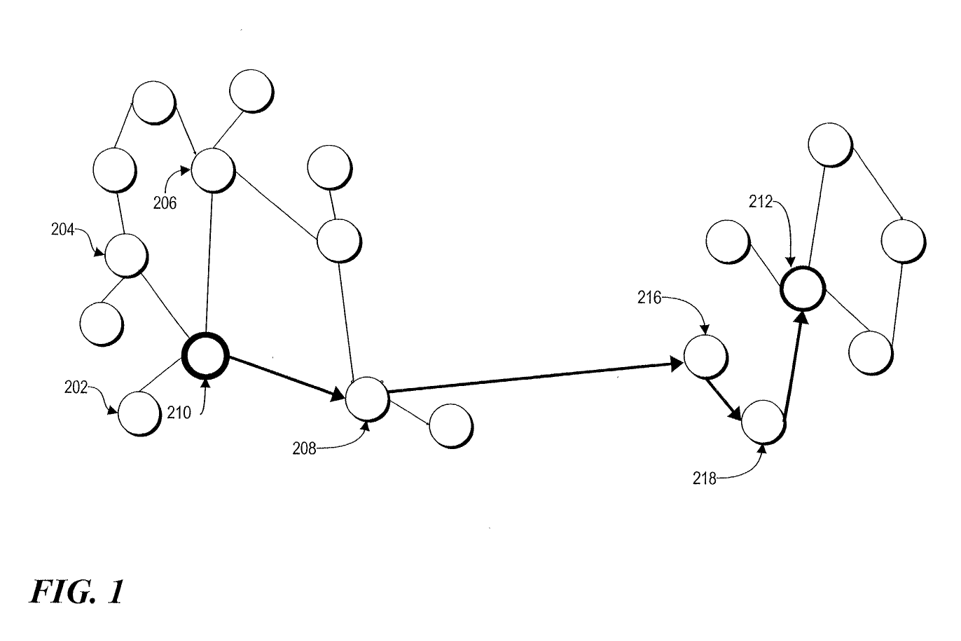

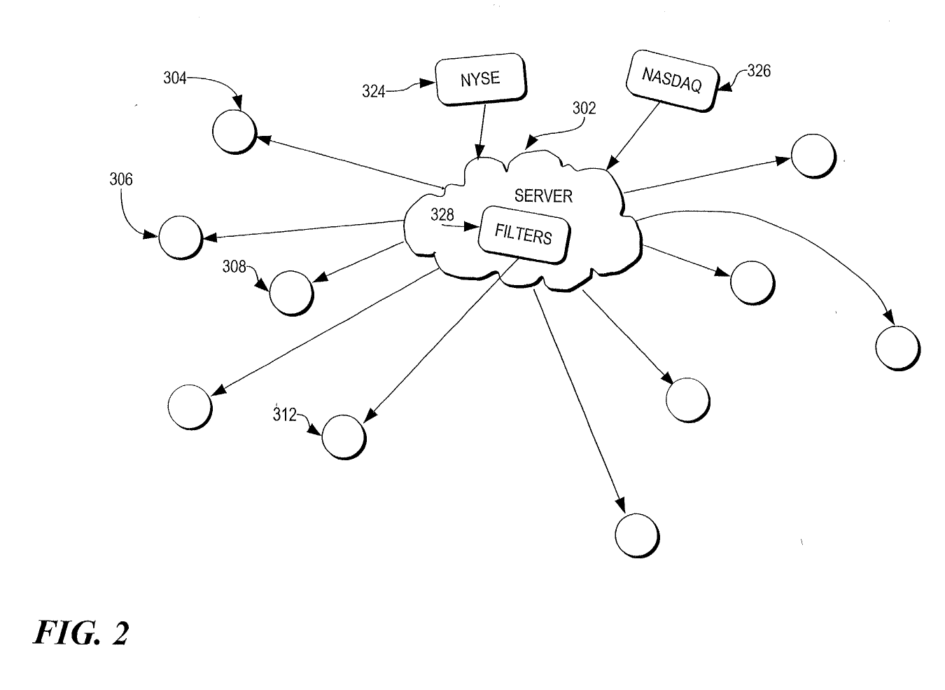

### DETAILED DESCRIPTION OF PREFERRED EMBODIMENTS

Preferred embodiments of the present invention will be described in detail hereinbelow with reference to the attached drawings.

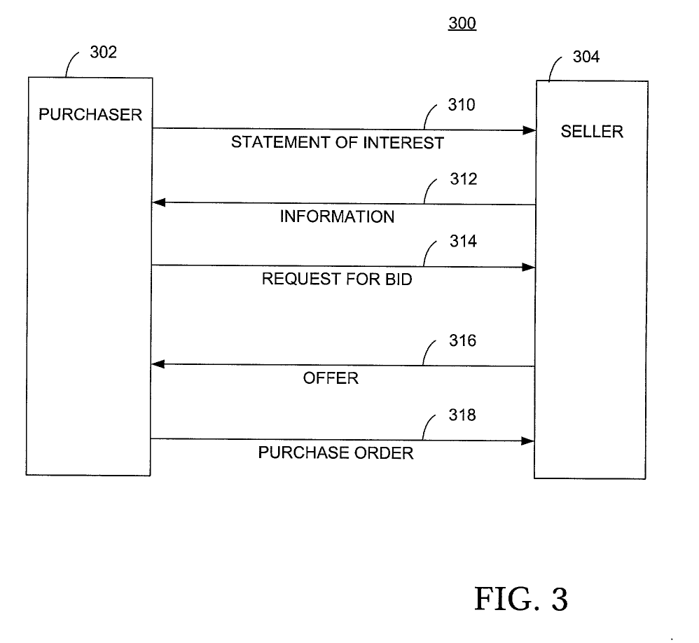

An exemplary commerce information flow 300, which illustrates the flow of information that occurs during an exchange in an online marketplace (such as a bidding system) according to one embodiment of the present invention, is shown in FIG. 3. The exemplary commerce information flow 300 shows a purchaser 302, one of a plurality of sellers 304 and the information that is communicated between these two types of users. An example use of the illustrated embodiment is the use by a purchaser 302 to solicit information from suppliers (i.e., sellers) of a good or service which the purchaser 302 requires. The purchaser 302 and sellers 304 exchange a series of information which culminates with the purchaser 302 selecting one or more of the sellers 304 from which to purchase the goods or services. The exemplary commerce information flow 300 may be accomplished via many media and environments, including written or electronic communications, or a combination of the two. Conventional communications have not allowed such parties to effectively communicate in an anonymous manner. Many entities value anonymous communication of some of the information illustrated in FIG. 3. The explanation of the exemplary commerce information 300 provided below illustrates one sample use of the present invention and is not limiting in the manner in which the exemplary embodiments or present invention may be utilized.

The exemplary commerce information flow 300 illustrates an example of the information that is communicated between the purchaser 302 and each seller within a plurality of sellers 304 that is participating in the information exchange. The purchaser 302 in the example embodiment initially posts a statement of interest 310. The statement of interest 310 is defined in more detail below and contains a specification of what the purchaser wishes to buy. The statement of interest 310 may be sent to specific sellers with whom the purchaser 302 has a relationship, but the statement of interest is typically posted so as to allow easy access by as large a group of sellers 304 who may have the desired goods or services to offer. The statement of interest 310 may be listed in newspapers or other written media, but is preferably posted to an online marketplace (e.g., electronic bulletin board) that specialize in the desired type of good or service via an electronic network (e.g., a computer network such as the Internet). While conventional techniques of posting a statement of interest 310 for broad dissemination and receipt by sellers 304 of the desired good or service require that the identity of the purchaser 302 be included with the statement of interest 310, preferred embodiments of the present invention utilize techniques such as those described below to maintain the anonymity of the purchaser 302 posting the statement of interest 310.

Each of the sellers 304 receives the statement of interest 310 via the electronic network, and then decides whether to respond to the statement of interest 310. A seller responds to the statement of interest by providing information 312 about that seller's goods or services that relate to the good or service specified in the statement of interest 310. One or more sellers 304 typically respond to the purchaser via the electronic network with one or more pieces of information 312 relating to goods and services offered for sale. The information 312 typically includes an identification of the seller sending the information 312 in order to facilitate return communications from the purchaser 302. In preferred embodiments of the present invention, the sellers sending the information 312 do not know the identity of the purchaser 302 that is receiving the information 312.

After receiving one or more responses containing information 312, the purchaser 302 issues a formal request for bid 314 to the sellers 304 via the electronic network (either to all of the sellers or only to those sellers that submitted information 312 to the purchaser). A request for bid 314 typically contains a more formal specification of the goods or services required, including required or desired terms and conditions for purchase. The purchaser 302 may incorporate information received from sellers into the request for bid 314. While conventional techniques require that the identity of the purchaser 302 be included with the request for bid 314, preferred embodiments of the present invention provide for anonymous transmittal of the request for bid 314. In other words, the request for bid 314 that is sent to the sellers 304 via the electronic network does not identify the purchaser 302. In some embodiments, the communications begin with the request for bid 314 from the purchaser (i.e., without first issuing a statement of interest to the sellers).

Each seller 304 that receives the request for bid 314 then decides whether or not to transmit an offer 316 to the purchaser 302 via the electronic network. The offer 316 is a formal specification of the terms and conditions for the purchase, as well as an exact specification of what is offered for sale. In preferred embodiments of the present invention, the sellers sending the offers 316 do not know the identity of the purchaser 302 that is receiving the offers. In other words, the sellers 304 transmit the offers for the good or service over the electronic network without knowing the destination of the offers (i.e., the purchaser).

In response to the receipt of one or more offers 316 (or alternatively after the purchaser has received information 312), the purchaser 302 issues a purchase order 318 to one or more of the sellers via the electronic network or some other communication means (e.g., by telephone or facsimile). A purchase order 318 operates as an acceptance of the offer transmitted by the seller 304 and forms a contract between the purchaser 302 and the seller 304. In preferred embodiments, the purchase order is the first communication in this transaction that identifies the purchaser 302 to the seller 304. Thus, the present invention provides anonymous communications from the purchaser 302 in making a purchase, and allows the purchaser 302 to decide if and when to disclose its identity to a seller.

Embodiments of the present invention utilize a communications system which allows for such anonymous communications. Each inquiry (i.e., message) sent by the purchaser 302, such as a statement of interest 310 or a request for bid 314, can be anonymously transmitted to a particular seller or published to multiple sellers over an electronic network. Preferably, the anonymously transmitted communications such as the request for bid 314 use verifiable information within the messages, such as digital signatures or other identifying data, to prevent duplication or use by different parties.

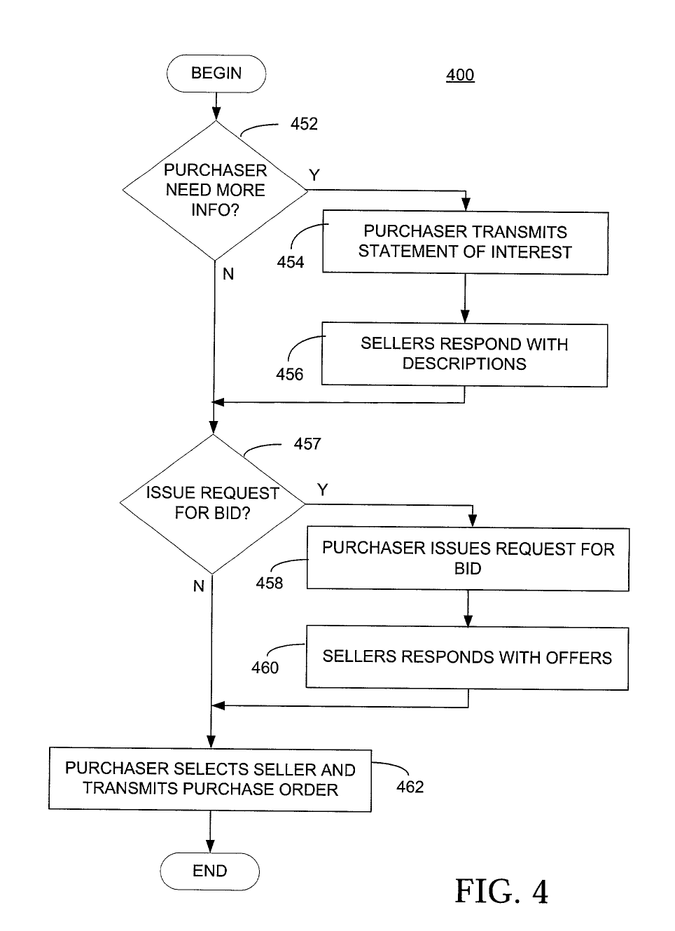

FIG. 4 illustrates the operational process implementing the above data flow. A purchaser 302 begins the process by deciding, in step 452, whether more information is required regarding the goods or services that the purchaser 302 wishes to purchase. If the purchaser 302 desires more information, the processing advances to step 454 in which the purchaser 302 causes a statement of interest 310 to be published on a channel associated with the desired good or service. Channels and publishing to a channel are described in detail below and are mechanisms of a publish/subscribe information exchange system utilized in preferred embodiments of the present invention. After the purchaser 302 causes the statement of interest 310 to be published, processing advances to step 456 in which one or more sellers 304 respond with information 312 that contains descriptions of their offering that complies with the specification of the good or service provided in the statement of interest 310. After the purchaser 302 receives the information 312 provided by the one or more sellers 304 as a response, the purchaser may alter the specification of the good or service to be purchased.

The processing of the example embodiment advances to step 457 to determine if the purchaser wishes to transmit a request for bid 314 after the sellers 304 have responded with information 312 in step 456, or after the purchaser 302 decides that more information is not needed in step 452. If the purchaser does transmit a request for bid 314, the processing advances to step 458. The processing of step 458 involves the purchaser 302 generating and publishing a request for bid 314. The request for bid 314 of the exemplary embodiment is described in detail below and contains a detailed specification of the good or service that the purchaser 302 wishes to purchase. The purchaser 302, in step 458, causes the request for bid to be published to a channel of the communication system of the exemplary embodiment to which suppliers of the specified good or service subscribe. This results in a large group of prospective sellers 304 receiving the request for bid 314.

Once the sellers that subscribe to that channel receive the published request for bid 314, each of the sellers 304 that decides to respond to the request for bid 314 responds, in step 460, by transmitting an offer 316 to the purchaser. The offer 316 of the exemplary embodiment is described in detail below and contains the specification of the good or service that the seller 304 is offering for sale.

After the purchaser 302 receives the offers 316 from one or more sellers 304, or if the purchaser did not publish a request for bid 314, the purchaser 302 decides, in step 462, from which seller or sellers 304 to purchase the required good or service. A purchaser 302 decides upon a particular seller 304 based upon information 312 received in step 456 or based upon any other information such as reputation or past experience. The processing of step 462 of the exemplary embodiment includes a human operator that reviews the received offers 316 to determine the offer or offers 316 that should be accepted. Once the purchaser 302 decides to accept an offer, a purchase order is transmitted to the selected seller 304 to form the purchase contract. The exemplary embodiment of the present invention allows the purchaser 302 to publish requests and transmit responses anonymously. When the purchaser 302 has communicated anonymously, an identity revelation is required in step 462 to facilitate formation of the purchase contract. Alternative embodiments require the identity of the purchaser to be exchanged sooner.

Preferred embodiments of the present invention allow purchasers of products to request information about a good or service in a standardized manner. For example, the requesting and providing of information can be accomplished via an XML schema. An XML format facilitates the automation of the purchasing process for each user because tools to develop and process XML formatted messages are readily available. The establishment of industry wide standards for message schema would further aid in the development of automated response processing.

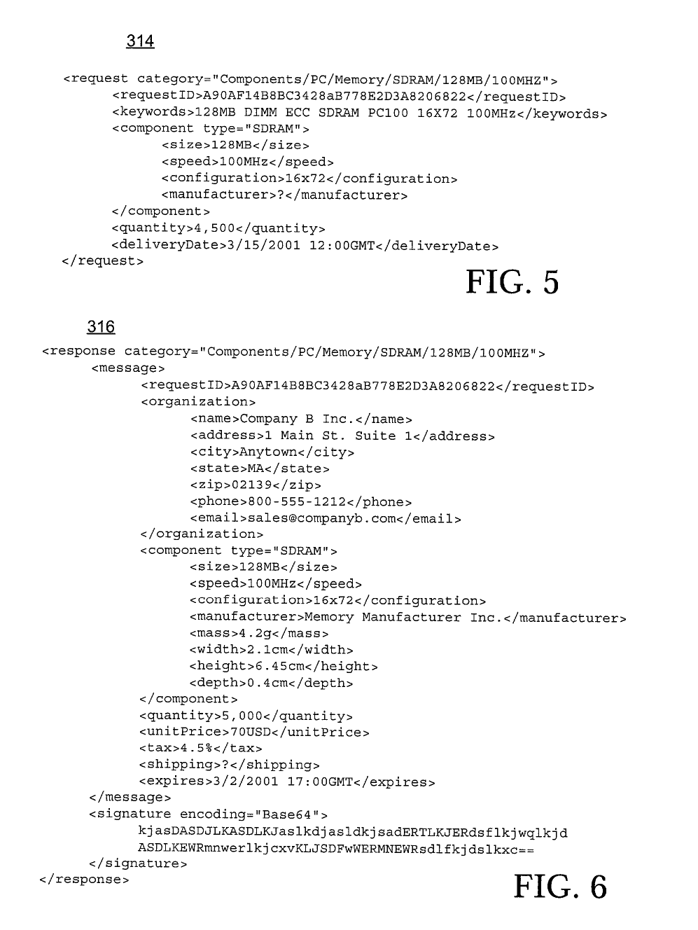

A request for bid 314 in XML data format according to an exemplary embodiment is illustrated in FIG. 5. This exemplary request for bid 314 is for four thousand, five hundred SDRAM memory units. In the exemplary embodiment of the present invention, this request for bid 314 is published to a channel that is targeted to subscribers that supply SDRAM units. An example of such a channel is the product category channel identified as “Components/PC/Memory.” The product category channel to which this exemplary request for bid 314 is published is defined by the “request category” tag. The product category channel “Components/PC/Memory/SDRAM/128MB/100MHz” is a channel to which suppliers of 128 Mbyte, 100 MHz SDRAM subscribe in order to receive statements of interest 310 and/or requests for bids 314 from prospective purchasers 302 for such products.

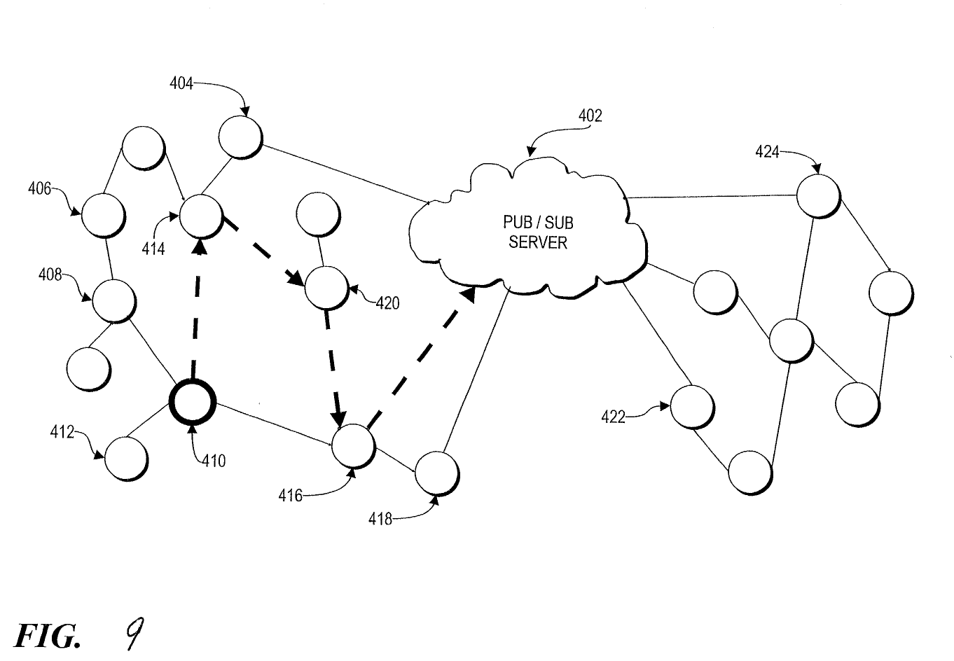

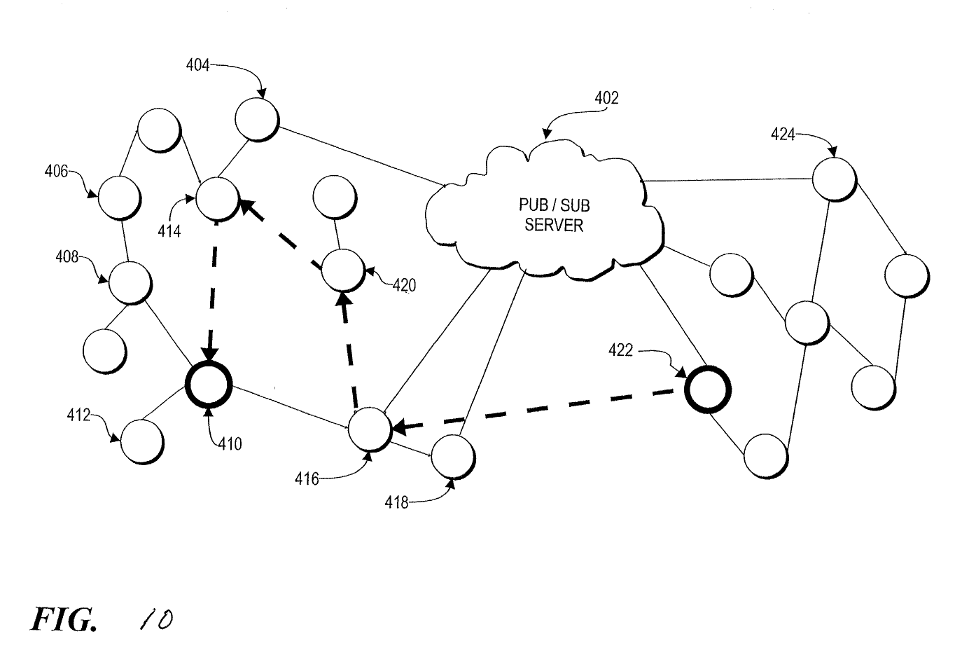

As shown, the request for bid specifies a request ID, a number of keywords to allow automated processing of the request, a specification of the component, a quantity desired and a requested delivery date. This request for bid 314 is received by each subscriber to the channel to which it is posted. This request for bid 314 is posted to the channel anonymously (e.g., via the process described below with reference to FIGS. 8 and 9) to prevent alerting competitors to the requester's requirements. Such an anonymous request for bid 314 can also include a purchase term specifying that the seller will maintain the name of the purchaser in confidence if a purchase is made. Thus, the present invention allows the purchaser to not inform the seller of its identity until a purchase order is transmitted.

Many suppliers of SDRAM receive the request for bid 314 described above through the network. Preferred embodiments of the present invention also include an automated system to receive and process the requests for bid 314 received by a seller. Such an automated system processes the XML data within the request for bid 314 and develops a response that conforms to the request for bid 314. The automated system of this exemplary embodiment then transmits a response in the form of an offer 316, as illustrated in FIG. 6.

The offer 316 also utilizes the XML data format to allow automated processing by the purchaser (such as filtering or offer selection) and includes a description of the responding organization, a detailed description of the product offered for sale, the quantity offered, price, tax information, shipping terms and offer expiration date. The offer is also digitally signed in order to prevent alteration or counterfeiting of the offer data and to verify the accuracy and source of the offer. If the request for bid 314 requires the seller 304 to maintain the identity of the purchaser 302 in confidence, the automated system can be configured to also include such a term in the offer 316. In alternative embodiments, a human operator manually causes the generation of the offer 316 that is sent to the purchaser in accordance with the operating requirements of that seller 304.

In this example, the request for bid 314 illustrated in FIG. 5 specified a quantity of four thousand, five hundred units. However, the offer 316 illustrated in FIG. 6 specifies a quantity of five thousand units. This is because the exemplary seller 304 sending the offer only sells in quantities of at least five thousand. While this is above the requested quantity, the offer was sent in hope that it is sufficiently cost effective to persuade the purchaser 304 to purchase the five thousand unit quantity. The generation of such a non-conforming offer can be automatically performed by the automated system of the seller 304 based on its programming, or could have been performed though the judgment of a human operator.

A purchaser 302 typically receives a number of offers 316. Preferably, a human operator reviews the responses and determines the best offer or offers) that should be accepted. Alternatively, the received offers can be automatically processed and one or more offers selected (or filtered out) according to predetermined criteria. When a purchaser 302 sends an anonymous request for bid 314, the offers 316 sent by the sellers 304 in response thereto are sent without knowing the identity of the requesting purchaser 302. To accept an offer 316, the purchaser 302 transmits a purchase order 318 to the seller 304 and at that time provides identity information to the seller 304. This maximizes the privacy of the purchaser in the transaction.

Embodiments of the present invention provide a robust communications architecture which facilitates purchasers in requesting information and/or bids and allows a large audience of sellers to be reached. Embodiments of the present invention further allow purchasers to request or provide information with anonymity. Such anonymous inquiry into the availability of goods or services or the specification of goods available from different sources is valuable to companies that wish to develop products in secret or that do not want to alert competitors to the type of goods or services being purchased. The ability to anonymously request information and/or bids allows these privacy objectives to be achieved, while at the same time reaching a large audience of sellers for the desired good or service. In preferred embodiment, the messages transmitted between purchasers and sellers are in a format (such as an XML format) that facilitates the automation of the purchasing process.

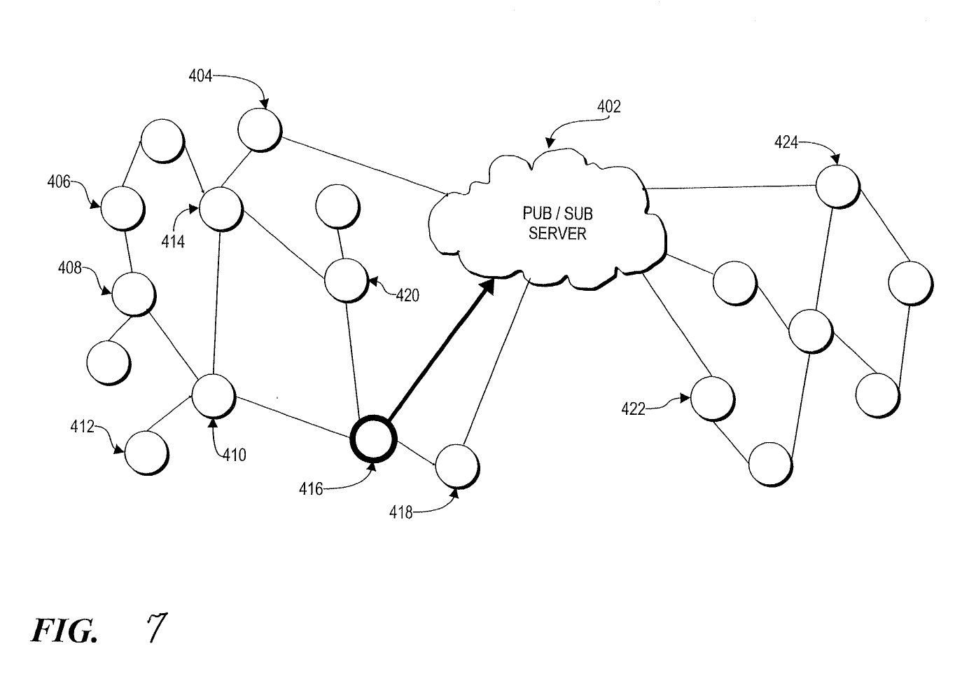

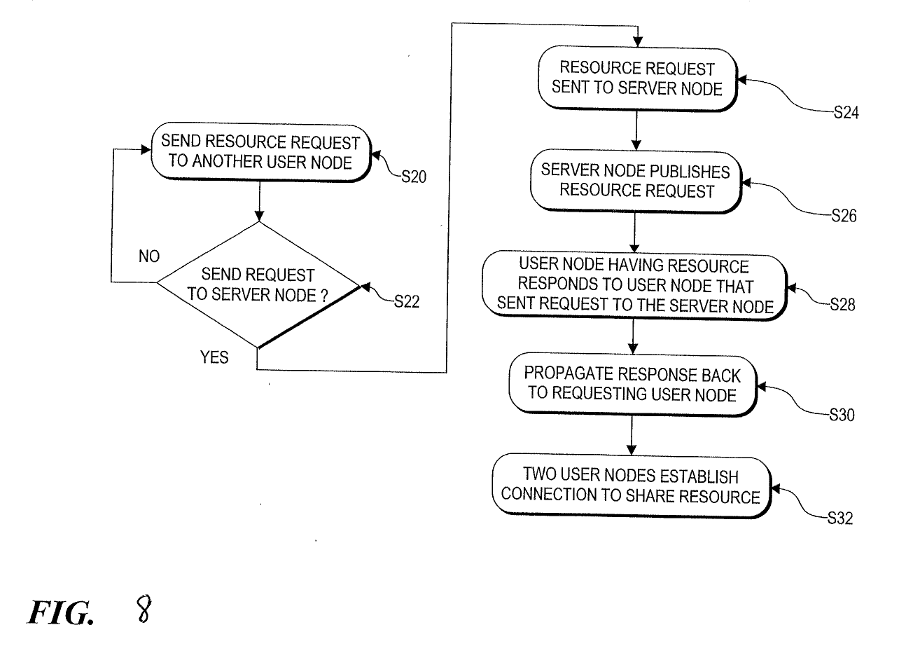

FIGS. 7 through 10 illustrate in detail a network framework that is used to implement such an online marketplace with anonymous communication in accordance with one preferred embodiment of the present invention. While this network framework is particularly suited for implementing an online marketplace (such as a bidding system) with anonymous communication, the present invention is not so limited. The online marketplace of the present invention can be implemented within any network or other system that can provide anonymity to communications from purchasers.

The network framework used to implement an online marketplace with anonymous communication in accordance with one preferred embodiment of the present invention is shown in FIG. 7. The framework includes a publish-subscribe server node 402 and multiple user nodes (e.g., 404, 406, and 410). In embodiments of the present invention, the server node 402 can be implemented by a single server or by a “server cloud” that is made up of any number of servers. The individual servers of such a server cloud can be connected to one another and to the Internet in various ways and can even be separated by great distances so as to provide an appropriate level of service and advantageous features such as data and path redundancy.

A user node 416 within this framework, which may be associated with a purchaser or seller of a good or service, joins the network by contacting the publish-subscribe server node 402 and subscribing to certain “channels” of messages. A seller in preferred embodiments subscribes to a channel or channels associated with the goods or services which that seller provides. Additionally, the joining user node 416 forms additional communications links by soliciting connections with and then directly connecting to at least one other user node 410, 418, and 420 (e.g., based on some criteria such as geographic location, connection speed, or common interests). In this manner, all of the user nodes in the network are connected to the centralized publish-subscribe server node for messaging (not shown for clarity) and also to one another through peer-to-peer connections that form a decentralized viral-type resource sharing network.

In preferred embodiments, the publish-subscribe messaging infrastructure supports two types of “channels”, or shared data streams. The first type of channel is a “node discovery channel” that is used to support the discovery of other user nodes in the decentralized network. To join the network, a user node announces itself using the publish-subscribe messaging infrastructure of the server node. In particular, a join announcement from the new user node is routed via the server node to one or more of the node discovery channels to solicit connections from other user nodes. Thus, the publish-subscribe infrastructure functions as a general purpose transport layer (like a layer above IP) that establishes connections to other user nodes to accomplish the broadcasting of join announcements.

Such join announcements can be divided among individual node discovery channels based on categories such as geographic location, network connection speed, types of resources available, and/or common interests. In preferred embodiments that implement electronic commerce systems, channels are also defined based upon categories of goods and services which subscribers desire to purchase or offer for sale. Thus, the new user node can discover remote user nodes (both geographically and with respect to network hops) and when connecting can favor nodes with the desired type of resources and/or acceptable connectivity attributes. Further, because each join announcement is only sent to the user nodes that are subscribed to certain channels, the user nodes of a very large network are not constantly flooded with join announcements.

The second type of channel is a “resource request channel” that is used to optimize the publication of resource requests such as requests for bids 314 or statements of interest 310. The server node publishes each resource request by sending it to all of the user nodes that are subscribed to a particular channel (or channels). These resource request channels can be divided into a rich taxonomy of resource types in order to allow the user nodes to effectively filter out undesired requests. Further, rather than reaching every user node in the network, the use of resource request channels allows a resource request to only reach a relevant subset of user nodes (i.e., those that subscribe to the relevant channel or channels).

One manner in which channels are defined in the example embodiment is by the definition of product category channels, which are channels organized by product categories. For example, separate product category channels are defined for different types of products (such as computers, home electronics, and chemicals), and can even be further divided with respect to one type of product (such as computer memory components and computer video components). Sellers 304 subscribe to the channels that relate to the products that they sell. Several channels may be joined so that information is received from or published to more than one channel. The joining of some channels is performed in some embodiments through programming at the server node.

Thus, a user node (i.e., seller) that only sells computer components is not bombarded with requests for bids or information regarding chemical products. Depending on the application, the requesting user node and/or the server node can determine the channel or channels on which to publish an individual announcement or resource request. Further, in preferred embodiments, a channel exists merely by virtue of being published to by a user node. Thus, any user node can create a new resource channel and then promote its availability for subscription in any conventional manner (e.g., through a web site, newsgroup, television, or direct mail advertising).

FIG. 8 is a flow chart of one embodiment of a process for sharing data to support obtaining a resource within such a scalable network framework. In this embodiment, resource requests are not sent directly to the server node in order to give enhanced privacy to the requesting user node. Resources within the electronic commerce model of the present invention include a good or service, or information regarding a good or service, in which a purchaser is interested. Whenever a first user node 416 (e.g., a node associated with a purchaser) in the network desires a resource (e.g., file containing a description of a product or service), the requesting first user node 410 sends (e.g., via a transmitting interface) a resource request (or query) to a second user node 414 to which it is connected in the decentralized network (step S20), as shown by the dashed arrows in FIG. 9. The second user node 414 then determines whether to send the request to the publish-subscribe server node 402 or to another user node to which it is connected in the decentralized network (step S22). Preferably, all of the user nodes are connected to the centralized publish-subscribe server node for messaging (not shown for clarity).

If it is decided not to send to the server node 402, then the second user node 414 forwards the resource request to another user node 420 to which it is connected (step S20), as shown in FIG. 9. This forwarding process is repeated with each user node that receives the resource request making the same determination (step S22). When a third user node 416 decides to send to the server node 402, the resource request is sent to the server node 402 (step S24), and the server node 402 publishes the resource request by sending it to all of the user nodes that are subscribed to the channel corresponding to that type of request (step S26).

In preferred embodiments, each determination of whether or not to send the request to the publish-subscribe server node is a “random” decision made by the user node based on a weighting factor of between 0 and 1 that gives the probability that the request will be sent to the server node. For example, if the weighting factor is 0.25, then there is a 25% chance that the user node will send the request to the server node and a 75% chance that the request will be forwarded to another user node. Thus, on average a weighting factor of 0.25 should cause resource requests to be forwarded to other user nodes three times before being sent to the publish-subscribe server node. The value of the weighting factor is set based on factors such as the desired level of privacy. Further, the weighting factor can be a fixed value that is used throughout the network or can be set by the user nodes on a per message basis. Other criteria such as a maximum number of forwards or a maximum elapsed time can also be incorporated into the determination that is made by each user node receiving the request.

In further embodiments, the determination of whether or not to send the request to the publish-subscribe server node is made based on some other criteria such as a fixed number of forwards. For example, in one embodiment each resource request is always forwarded through three user nodes and then sent to the publish-subscribe server node. Preferably, whenever a resource request is to be forwarded on to another user node, the choice of which other user node will receive the forwarded request is made through a random selection of one of the user nodes to which the forwarding user node is connected.

After the resource request (e.g., request for bid) is published by the server node 402, a fourth user node 422 that receives the request and is willing to provide the resource (e.g., good or service) contacts the first user node 410. More specifically, as shown in FIG. 10 the fourth user node 422 sends a response (e.g., offer) to the third user node 416 (step S28), which had sent the resource request to the server node 402 for publication. The third user node 416 forwards the response to the user node 420 from which it received the resource request, and this forwarding process is repeated until the response reaches the first user node 410 (step S30). At this point, the first user node 410 can contact the fourth user node 422 to set up a direct peer-to-peer connection to share the requested resource (step S32).

In preferred embodiments, the response (e.g., offer) from a seller 304 contains metadata concerning the requested good or service. When the response is received, the purchaser 302 evaluates the metadata and then decides whether or not to make a direct connection with the seller in order to exchange further data (e.g., send a purchase order). If multiple responses are received, the requesting user node can evaluate the metadata in each response and then select one or more of the sellers 304 based on any criteria (e.g., past experience, reputation, connection speed, or physical location).

Additionally, in preferred embodiments, responses from sellers 304 are routed through existing connections (such as the one the resource request had traversed through the server node to reach the seller). Otherwise, with each seller initiating a new point-to-point connection, the purchaser 302 receiving the responses could be overwhelmed whenever a large number of responses are received. Alternatively, the server node could set up a matching “one-time” response channel or a permanent response channel to be used by sellers 304 responding to the request. The publishing of responses over a permanent response channel would facilitate “passive” user nodes that archive responses of possible interest for future use.

Because resource requests are forwarded through one or more other user nodes rather than being sent directly to the server node, privacy is offered to requesting user nodes (e.g., purchasers). The actual user node requesting the good or service remains anonymous to the server node, so the server node cannot keep track of which users are requesting which goods and services. As in a conventional viral network, only the user node (e.g., seller) that actually provides the good or service has knowledge of the request and the identity of the requesting node (e.g., purchaser).

Further, unlike a conventional viral network, the use of a publish-subscribe messaging infrastructure layer allows for efficient resource discovery in a network having a very large number of user nodes. In particular, the publish-subscribe messaging infrastructure layer allows a resource request to reach nodes that are separated from the requesting node by a direct-connect path that includes a very large number of intermediary nodes. Additionally, because each search request is published to all of the user nodes that subscribe to the relevant channel, it is possible to perform an exhaustive (or at least very extensive) search for the requested resource within an acceptable time frame in a network that contains a very large number of user nodes. Thus, scalability can be achieved in a decentralized network while enhanced user privacy is maintained.

In some embodiments, besides sending a resource request to the second user node 414 for eventual publication by the server node 402, the first node 410 also sends the resource request to all of the other user nodes 408, 412, and 416 to which it is connected in the decentralized network. This process is repeated with each user node that receives the request passing it on to the user nodes to which it is connected, so as to propagate the request through the user nodes of the decentralized network. For example, the request reaches user node 406 by being passed through node 408. Further, in one embodiment each user node that receives the resource request from the server node (e.g., user node 422) also sends the resource request to all of the user nodes to which it is connected in the decentralized network. Thus, in such embodiments resource requests are both published through the messaging infrastructure layer and propagated through the user nodes of the decentralized network. Because this dual path process offers an alternative to the request propagation path that passes through the centralized server node, the single point of failure is eliminated. In other words, the resource request is propagated to other user nodes even when the server node is down. Further, in such embodiments, it is not necessary for all of the user nodes to be connected to, or even know about the presence of, the publish-subscribe infrastructure. Such a user node can merely forward resource requests to all of the user nodes to which it is connected. This feature allows implementation in an existing network without requiring the modification of all user nodes.

The embodiments of the scalable network framework described above require some mechanism for identifying individual messages. In preferred embodiments, every message (i.e., resource request or response) is assigned a unique identification number. For example, one embodiment employs an algorithm developed by Microsoft Corporation that allows each user node to individually generate globally-unique message identifiers (GUIDs) that are very likely to be globally unique. Additionally, each user node must store (e.g., in a table) at least a limited history of forwarded messages in order to allow responses to reach the user node that sent a message through the same path. Further, some embodiments include a mechanism to prevent the looping of a resource request. For example, the globally-unique message identifiers GUIDs and node history tables can easily be used to create an anti-looping mechanism.

While the embodiments of the scalable network framework described above relate to a single server node, multiple publish-subscribe server nodes can be provided in the network to further minimize “point of failure” concerns. Further, competing providers may coexist in the network by operating different server nodes and competing for user node subscriptions. Additionally, the features of the different embodiments described above can be combined for further applications. Other design choices, such as network protocols, forwarding criteria, and membership criteria, could easily be adapted.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when loaded and executed, controls the computer system such that it carries out the methods described herein.

The present invention can also be embedded in a computer program product, which comprises all the features enabling the implementation of the methods described herein, and which—when loaded in a computer system—is able to carry out these methods. In the present context, a “computer program” includes any expression, in any language, code or notation, of a set of instructions intended to cause a system having an information processing capability to perform a particular function either directly or after either or both of the following: a) conversion to another language, code, or notation; and b) reproduction in a different material form.

Each computer system may include one or more computers and a computer readable medium that allows the computer to read data, instructions, messages, or message packets, and other computer readable information from the computer readable medium. The computer readable medium may include non-volatile memory such as ROM, Flash memory, a hard or floppy disk, a CD-ROM, or other permanent storage. Additionally, a computer readable medium may include volatile storage such as RAM, buffers, cache memory, and network circuits. Furthermore, the computer readable medium may include computer readable information in a transitory state medium such as a network link and/or a network interface (including a wired network or a wireless network) that allow a computer to read such computer readable information.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for communicating between a purchaser and a plurality of sellers in an online marketplace, said method comprising the steps of:
transmitting a request for bid for a good or service to the sellers via an electronic network, the request for bid not identifying the purchaser;
receiving at least one offer for the good or service from at least one of the sellers via the electronic network, the sellers sending the offers not knowing the identity of the purchaser that is receiving the offers; and
after receiving the offers, communicating a purchase order to one of the sellers that submitted an offer in order to purchase the good or service, the purchase order identifying the purchaser.

2. The method of claim 1, further comprising the steps of:
transmitting a statement of interest to the sellers via the electronic network, the statement of interest not identifying the purchaser; and
receiving information in response to the statement of interest from at least one of the sellers via the electronic network, the sellers sending the information not knowing the identity of the purchaser.

3. The method of claim 2, wherein in the step of transmitting the request for bid, the request for bid is transmitted to only the sellers that sent the information to the purchaser.

4. The method of claim 1, wherein in the step of transmitting the request for bid, the request for bid for the good or service is sent to all of the sellers that subscribe to a channel relating to the good or service.

5. The method of claim 1, wherein the step of transmitting the request for bid includes the sub-steps of:
receiving the request for bid at a first user node of the electronic network;
determining whether or not to send the request for bid to a server node;
forwarding the request for bid to a second user node of the electronic network through a direct connection, when it is determined not to send the request for bid to the server node; and
sending the request for bid to the server node for publication, when it is determined to send the request for bid to the server node.

6. The method of claim 5, wherein the step of transmitting the request for bid further includes the sub-step of publishing the request for bid via the server node to all of the sellers that are subscribed to one or more selected channels.

7. The method of claim 5, wherein the step of transmitting the request for bid further includes the sub-steps of:
sending the request for bid from the purchaser to the first user node; and
repeating the sub-steps of determining and forwarding until in the determining step a user node that received the request for bid decides to send the request for bid to the server node.

8. A method for communicating between a purchaser and a seller in an online marketplace, said method comprising the steps of:
receiving a request for bid for a good or service from the purchaser via an electronic network, the request for bid not identifying the purchaser;
transmitting an offer for the good or service to the purchaser via the electronic network, the seller sending the offer not knowing the identity of the purchaser that is receiving the offer; and
receiving a purchase order from the purchaser so as to form a contract for purchasing the good or service, the purchase order identifying the purchaser.

9. The method of claim 8, further comprising the steps of:
receiving a statement of interest from the purchaser via the electronic network, the statement of interest not identifying the purchaser; and
transmitting information in response to the statement of interest to the purchaser via the electronic network, the seller sending the information not knowing the identity of the purchaser.

10. The method of claim 8, wherein the purchase order is the first communication in a transaction that identifies the purchaser to the seller.

11. The method of claim 8, further comprising the step of subscribing to one or more channels for receiving requests for bids, each of the channels relating to different goods or services.

12. The method of claim 8, wherein the step of receiving the request for bid includes the sub-steps of:
receiving the request for bid at a first user node of the electronic network;
determining whether or not to send the request for bid to a server node;
forwarding the request for bid to a second user node of the electronic network through a direct connection, when it is determined not to send the request for bid to the server node; and
sending the request for bid to the server node for publication, when it is determined to send the request for bid to the server node.

13. The method of claim 12, wherein the step of receiving the request for bid further includes the sub-steps repeating the sub-steps of determining and forwarding until in the determining step a user node that received the request for bid decides to send the request for bid to the server node.

14. A method for operating an online marketplace, said method comprising the steps of:
receiving a request for bid for a good or service from a purchaser, the request for bid not identifying the purchaser;
transmitting the request for bid that does not identify the purchaser to a plurality of sellers via an electronic network;
receiving at least one offer for the good or service from at least one of the sellers via the electronic network, the sellers sending the offers not knowing the identity of the purchaser that will receive the offers; and
transmitting the offers to the purchaser.

15. The method of claim 14, further comprising the step of communicating a purchase order from the purchaser to one of the sellers that submitted an offer in order to purchase the good or service, the purchase order identifying the purchaser.

16. The method of claim 14, further comprising the steps of:
receiving a statement of interest from a purchaser via the electronic network, the statement of interest not identifying the purchaser;
transmitting the statement of interest that does not identify the purchaser to the sellers via the electronic network;
receiving information in response to the statement of interest from at least one of the sellers via the electronic network, the sellers sending the information not knowing the identity of the purchaser; and
transmitting the information to the purchaser.

17. The method of claim 16, wherein in the step of transmitting the request for bid, the request for bid is transmitted to only the sellers that sent the information in response to the statement of interest.

18. The method of claim 14, wherein in the step of transmitting the request for bid, the request for bid for the good or service is sent to all of the sellers that subscribe to a channel relating to the good or service.

19. The method of claim 14, wherein the step of transmitting the request for bid includes the sub-steps of:
receiving the request for bid at a first user node of the electronic network;
determining whether or not to send the request for bid to a server node;
forwarding the request for bid to a second user node of the electronic network through a direct connection, when it is determined not to send the request for bid to the server node; and
sending the request for bid to the server node for publication, when it is determined to send the request for bid to the server node.

20. The method of claim 19, wherein the step of transmitting the request for bid further includes the sub-step of publishing the request for bid via the server node to all of the sellers that are subscribed to one or more selected channels.

21. The method of claim 19, wherein the step of transmitting the request for bid further includes the sub-step of repeating the sub-steps of determining and forwarding until in the determining step a user node that received the request for bid decides to send the request for bid to the server node.

22. A machine-readable medium encoded with a program for operating an online marketplace, said program containing instructions for performing the steps of:
receiving a request for bid for a good or service from a purchaser, the request for bid not identifying the purchaser;
transmitting the request for bid that does not identify the purchaser to a plurality of sellers via an electronic network;
receiving at least one offer for the good or service from at least one of the sellers via the electronic network, the sellers sending the offers not knowing the identity of the purchaser that will receive the offers; and
transmitting the offers to the purchaser.

23. The machine-readable medium of claim 22, wherein said program further contains instructions for performing the step of communicating a purchase order from the purchaser to one of the sellers that submitted an offer in order to purchase the good or service, the purchase order identifying the purchaser.

24. The machine-readable medium of claim 22, wherein said program further contains instructions for performing the steps of:
receiving a statement of interest from a purchaser via the electronic network, the statement of interest not identifying the purchaser;
transmitting the statement of interest that does not identify the purchaser to the sellers via the electronic network;
receiving information in response to the statement of interest from at least one of the sellers via the electronic network, the sellers sending the information not knowing the identity of the purchaser; and
transmitting the information to the purchaser.

25. The machine-readable medium of claim 22, wherein the step of transmitting the request for bid includes the sub-steps of:
receiving the request for bid at a first user node of the electronic network;
determining whether or not to send the request for bid to a server node;
forwarding the request for bid to a second user node of the electronic network through a direct connection, when it is determined not to send the request for bid to the server node; and
sending the request for bid to the server node for publication, when it is determined to send the request for bid to the server node.

26. The machine-readable medium of claim 25, wherein the step of transmitting the request for bid further includes the sub-step of publishing the request for bid via the server node to all of the sellers that are subscribed to one or more selected channels.

27. The machine-readable medium of claim 25, wherein the step of transmitting the request for bid further includes the sub-step of repeating the sub-steps of determining and forwarding until in the determining step a user node that received the request for bid decides to send the request for bid to the server node.
